(19) United States
(12) Patent Application Publication
(10) Pub. No.: US 2020/0137322 A1
(43) Pub. Date: Apr. 30, 2020

(54) IMAGE PROCESSING APPARATUS

(71) Applicant: DENSO CORPORATION, Kariya-city (JP)

(72) Inventors: Nobuyuki YOKOTA, Kariya-city (JP); Hirohiko YANAGAWA, Kariya-city (JP)

(21) Appl. No.: 16/662,573

(22) Filed: Oct. 24, 2019

(30) Foreign Application Priority Data
Oct. 26, 2018 (JP) 2018-202196

(51) Int. Cl. H04N 5/262; G06T 7/11; G06K 9/00; G06K 9/62; G06T 7/50; H04N 5/445; H04N 5/232; B60R 1/00

(52) U.S. Cl. CPC H04N 5/2628; G06T 7/11; G06K 9/00805; G06K 9/628; H04N 5/247; H04N 5/44591; H04N 5/23238; B60R 1/00; G06T 2207/30252; G06T 7/50

(57) ABSTRACT

In an image processing apparatus, an image obtaining unit obtains an image of a region around a vehicle captured by an imaging device, and a region identifier identifies, based on the obtained image, a travelable region and a non-travelable region in the obtained image. The travelable region is a region in which the vehicle is travelable, and the non-travelable region is a region except for the travelable region in the obtained image. A boundary identifier identifies, in the obtained image, a boundary between the travelable region and non-travelable region. An image display unit displays the travelable region and non-travelable region while distinguishing the travelable region and non-travelable region from one another.

### CROSS REFERENCE TO RELATED APPLICATION

This application is based on and claims the benefit of priority from Japanese Patent Applications No. 2018-202196 filed on Oct. 26, 2018, the disclosure of which is incorporated in its entirety herein by reference.

### TECHNICAL FIELD

The present disclosure relates to image processing apparatuses for displaying, on a display, a captured image of a region around a vehicle.

### BACKGROUND

An example of known image displaying systems captures an image of a region around a vehicle, and displays the captured image on an in-vehicle display as, for example, an around-view image.

### SUMMARY

An image processing apparatus according to an exemplary aspect of the present disclosure identifies a travelable region and a non-travelable region in a captured image, and identifies, in the captured image, a boundary between the travelable region and non-travelable region. The image processing apparatus displays the travelable region and non-travelable region while distinguishing the travelable region and non-travelable region from one another.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the configuration of an image display system according to an exemplary embodiment of the present disclosure;

FIG. 2 is a side view schematically illustrating an example of where cameras are located to a vehicle according to the exemplary embodiment;

FIG. 3 is a flowchart schematically illustrating a display routine carried out by a CPU of an electronic control unit illustrated in FIG. 1;

FIG. 4A is a view schematically illustrating an example of a front image captured by a front camera illustrated in FIG. 1;

FIG. 4B is a view schematically illustrating an example of a segmented image generated by the CPU;

FIG. 4C is a view schematically illustrating an example of a scanned image generated by the CPU;

FIG. 4D is a view schematically illustrating an example of a highlighted image generated by the CPU;

FIG. 5 is a side view schematically illustrating an example of how bird's-eye view conversion is carried out according to the exemplary embodiment;

FIG. 6 is a top view schematically illustrating an example of a bird's-eye view image generated by the CPU;

FIG. 7 is a top view schematically illustrating an example of a boundary stored in a memory of the electronic control unit (ECU)

FIG. 8 is a top view schematically illustrating an example of a highlighted travelable region in a collective bird's-eye view image generated by the CPU;

FIG. 9 is a top view schematically illustrating an example of a highlighted non-travelable region in a collective bird's-eye view image generated by the CPU;

FIG. 10 is a top view schematically illustrating an example of a near range and a middle range defined around the vehicle in a near-field image according to the exemplary embodiment;

FIG. 11 is a graphics table schematically illustrating first to third examples of a combined bird's-eye view image when a front highlighted image is selected as the near-field image according to the exemplary embodiment;

FIG. 12 is a graphics table schematically illustrating first to third examples of a combined bird's-eye view image when a left highlighted image is selected as the near-field image according to the exemplary embodiment;

FIG. 13 is a flowchart schematically illustrating a subroutine in step S190 of the display routine illustrated in FIG. 3;

FIG. 14 is a table schematically illustrating an example of a relationship among

(1) A detected at least one nearest boundary point

(2) At least one of a travelling-directional highlighted image, a left highlighted image, and a right highlighted image, which includes the at least one nearest boundary point

(3) A particular interest image displayed on a display; and

FIG. 15 is a top view schematically illustrating an example of a collective bird's-eye image in which a nearest boundary point is located in an overlapped region between front and right bird's-eye images.

### DETAILED DESCRIPTION OF EMBODIMENT

### View Point

Japanese patent application publication No. 2003-189293, which will be referred to as a published document, discloses a system for displaying a bird's-eye view image showing a vehicle and the surrounding of the vehicle to thereby assist the driver's safety drive of the vehicle. For example, the system converts each of images of regions around the vehicle, which are captured by respective plural cameras, into an image of a corresponding region viewed from a virtual camera located above the vehicle, and combines the converted images with each other to thereby create a bird's-eye view image.

Such an image displaying system is capable of capturing an around-view image or a panoramic image, of a region around a vehicle using a fisheye view camera or a wide-angle view camera with a substantially 180° field of view. This image displaying system however may cause the around-view image captured by the fisheye view camera or wide-angle view camera to have distortion. This may make it difficult for a user, such as a driver, of the vehicle to recognize a feeling of distance between the vehicle and at least one solid object included in the around-view image.

As disclosed in the published patent document, such a system for displaying a bird's-eye view image performs bird's-eye view conversion. The bird's-eye view conversion converts the coordinates of each pixel in each captured image into coordinates of a corresponding pixel on a plane that is estimated as a road surface in the corresponding captured image. This conversion projects each captured image on the estimated road surface as a corresponding projected image.

This bird's-eye view conversion therefore may result in the shape of at least one solid object included in at least one captured image being converted into an extending shape relative to the position of the corresponding at least one camera; the extending shape of the at least one solid object shows that the higher the height of at least one solid object, the farther the at least one solid object relative to the vehicle.

This therefore may eliminate a stereoscopic effect from the at least one solid object included in the corresponding at least one projected image. This may therefore make it difficult for a user, such as a driver, of the vehicle, to recognize a feeling of distance between the vehicle and the at least one solid object included in the at least one captured image.

Thus, as described above, each of the conventional systems set forth above may make it difficult for a driver to recognize a feeling of distance between the vehicle and at least one solid object included in an around-view image or a bird's-eye view image displayed in an in-vehicle display. This may therefore result in such a driver having a difficulty in determining whether to distinguish, in the around-view image or bird's-eye view image, a travelable region in which the vehicle is able to travel from a non-travelable region in which the vehicle is unable to travel due to the existence of at least one solid object.

From this viewpoint, the present disclosure seeks to provide image processing apparatuses, each of which is capable of improving, in a displayed image, the viewability of a boundary between a travelable region that is travelable for a vehicle and a non-travelable region that is non-travelable for the vehicle.

An image processing apparatus according to an exemplary aspect of the present disclosure includes an image processing apparatus. The image processing apparatus includes an image obtaining unit configured to obtain an image of a region around a vehicle captured by an imaging device. The image processing apparatus includes a region identifier configured to identify, based on the obtained image, a travelable region and a non-travelable region in the obtained image. The travelable region is a region that is travelable for the vehicle, and the non-travelable region is a region except for the travelable region in the obtained image. The image processing apparatus includes a boundary identifier configured to identify, in the obtained image, a boundary between the travelable region and non-travelable region. The image processing apparatus includes an image display unit configured to display the travelable region and non-travelable region while distinguishing the travelable region and non-travelable region from one another.

This configuration enables the travelable region, in which the vehicle is travelable, and the non-travelable region except for the travelable region in the obtained image to be displayed while they are distinguished from each other. This therefore enables the viewability of the boundary between the travelable region and the non-travelable region to be improved.

### Embodiment

The following describes an exemplary embodiment of the present disclosure with reference to the accompanying drawings. Note that the exemplary embodiment merely represents an example of the present disclosure, and does not limit the present disclosure to the following specific configuration of the exemplary embodiment. Modification of the following specific configuration may be adopted based on the present disclosure.

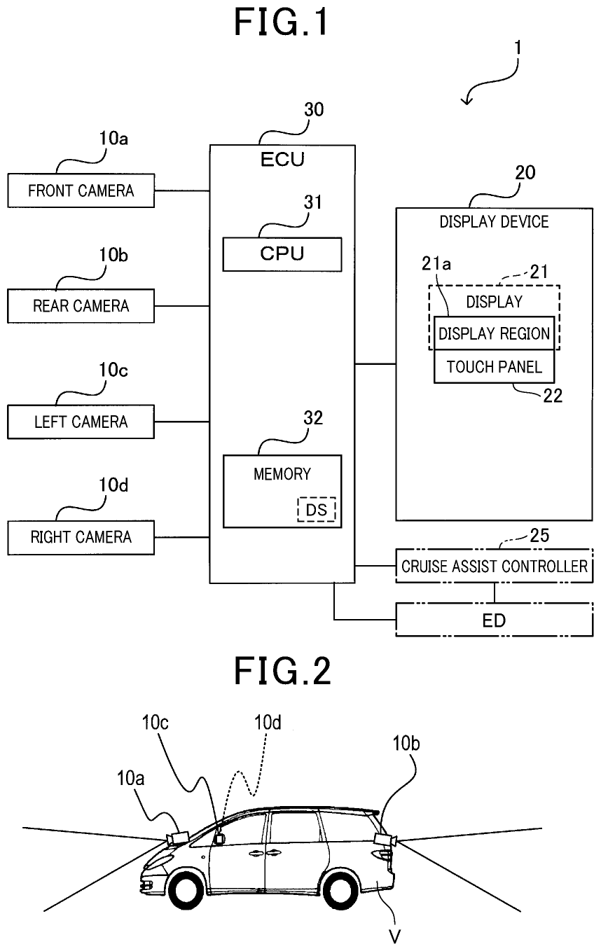

FIG. 1 schematically illustrates an example of the specific configuration of an image display system 1 according to the exemplary embodiment of the present disclosure. The image display system 1 is installed in a vehicle V.

Referring to FIG. 1, the image display system 1 include a front camera 10a, a rear camera 10b, a left camera 10c, a right camera 10d, a display device 20, and an electronic control unit (ECU) 30. The cameras 10a to 10d are communicably connected to the ECU 30, and the ECU 30 is communicably connected to the display device 20. The following describes the vehicle V incorporating therein the image display system 1 as an own vehicle V.

For example, the image display system 1 can include a cruise assist controller 25, so that the image display system 1 can serve as a cruise assist system.

Each of the front camera 10a, rear camera 10b, left camera 10c, and right camera 10d is configured to capture an image of a corresponding one of predetermined front, rear, left, and right imaging regions with respect to the vehicle V. The cameras 10a to 10d for example have the same basic configuration as each other.

The following can refer to images captured by the respective front, rear, left, and right cameras 10a, 10b, 10c, and 10d as front, rear, left, and right images. The following describes the cameras 10a to 10d collectively as cameras 10 or image devices 10.

For example, each of the cameras, i.e. image devices, 10 is comprised of an imager and a lens.

Referring to FIG. 2, the front camera 10a is mounted to, for example, a predetermined front portion of the vehicle V, and the rear camera 10b is mounted to, for example, a predetermined rear portion of the vehicle V.

A front bumper of the vehicle V or therearound, a rear-view mirror of the vehicle V or therearound, or an instrumental panel of the vehicle V or therearound can be selected as the front portion of the vehicle V to which the front camera 10a is mounted. Similarly, a rear bumper of the vehicle V or therearound can be selected as the rear portion of the vehicle V to which the rear camera 10b is mounted. If the vehicle V is designed as a hatchback, the hatch or therearound can be selected as the rear portion of the vehicle V to which the rear camera 10b is mounted.

The left and right cameras 10c and 10d are mounted to, for example, predetermined positions of respective left-side and right-side portions of the vehicle V. For example, each of the left and right cameras 10c and 10d is embedded in the corresponding one of the left and right sideview mirrors while the corresponding lens is exposed from the corresponding one of the left and right sideview mirrors. Note that the location to which each of the left and right cameras 10c and 10d is mounted is not limited to the corresponding one of the left and right sideview mirrors. As another example, the left camera 10c can be mounted to a substantially middle portion of the left-side of the body of the vehicle V in the longitudinal direction of the vehicle V. Similarly, the right camera 10d can be mounted to a substantially middle portion of the right-side of the body of the vehicle V in the longitudinal direction of the vehicle V.

In particular, the front camera 10a is mounted to the front portion of the vehicle V while an optical axis of the lens is directed toward the forward direction of the vehicle V. Similarly, the rear camera 10b is mounted to the rear portion of the vehicle V while an optical axis of the lens is directed toward the rearward direction of the vehicle V.

Additionally, the left camera 10c is mounted to the right-side portion of the vehicle V while an optical axis of the lens is directed toward the left direction of the vehicle V, which is substantially perpendicular to, i.e. has a substantially 90 degrees with respect to, the forward direction of the vehicle V. Similarly, the right camera 10d is mounted to the right-side portion of the vehicle V while an optical axis of the lens is directed toward the right direction of the vehicle V, which is substantially perpendicular to, i.e. has a substantially 90 degrees with respect to, the forward direction of the vehicle V.

As described above, the front camera 10a is configured to capture an image of the front imaging region with respect to the vehicle V defined by the 180° diagonal field of view, and the rear camera 10b is configured to capture an image of the rear imaging region with respect to the vehicle V defined by the 180° diagonal field of view. Similarly, the left camera 10c is configured to capture an image of the left imaging region with respect to the vehicle V defined by the 180° diagonal field of view, and the right camera 10d is configured to capture an image of the right imaging region with respect to the vehicle V defined by the 180° diagonal field of view.

In other words, the front camera 10a is configured to monitor a front view field, which corresponds to the front imaging region, with respect to the vehicle V, and the rear camera 10b is configured to monitor a right view field, which corresponds to the rear imaging region, with respect to the vehicle V. Similarly, the left camera 10c is configured to monitor a left view field, which corresponds to the left imaging region, with respect to the vehicle V, and the right camera 10d is configured to monitor a right view field, which corresponds to the right imaging region, with respect to the vehicle V.

The positional relationship of each of the pair of front and left cameras 10a and 10c, the pair of left and rear cameras 10c and 10b, the pair of rear and right cameras 10b and 10d, and the pair of right and front cameras 10d and 10a is defined as an adjacent positional relationship. For example, the front and left cameras 10a and 10c have the adjacent positional relationship therebetween. The cameras of each pair, which have the adjacent positional relationship therebetween, are arranged such that their imaging regions partially overlap with each other. For example, the front and left cameras 10a and 10c, which have the adjacent positional relationship therebetween, are arranged such that the front imaging region and left imaging region partially overlap with each other.

As described above, each of the cameras 10 is configured as a digital camera comprised of an imager, such as a CCD sensor or a MOS sensor, and a lens.

The imager is comprised of a plurality of light receiving elements, which respectively correspond to a plurality of pixels, two-dimensionally arranged in both vertical and horizontal directions corresponding to the respective height direction and width direction of the vehicle V. The two-dimensionally arranged pixels constitute a light receiving surface of the imager. The lens is designed as, for example, a fisheye lens or a wide-angle view lens having a substantially 180° diagonal field of view, i.e. angle of view. That is, each camera 10a to 10d is designed as a fisheye view camera or a wide-angle view camera, which has a substantially 180° diagonal field of view.

The lens of each camera 10a to 10d focuses light incident from, for example, the corresponding imaging region on the light receiving surface of the imager. The imager of each camera 10a to 10d receives light focused on the light receiving surface thereof, so that each of the two-dimensionally arranged light-sensitive elements (pixels) receives a corresponding light component.

Then, the imager of each camera 10a to 10d converts, using each of the light receiving elements, the intensity or luminance level for each of red, green, and blue (RGB) of a corresponding received light component into an analog pixel value or an analog pixel signal that is proportional to the luminance level of the corresponding received light component; the analog pixel values of all the pixels, i.e. light receiving elements, constitute an analog frame image.

That is, the number of horizontally-arranged pixels and the number of pixels vertically-arranged pixels of the light receiving surface of the imager defines a predetermined size of the analog frame image. In other words, the two-dimensionally arranged pixels of the light receiving area of each camera 10 represents a pixel array that is configured as a predetermined number of columns by a predetermined number of rows.

Note that the number of horizontally-arranged pixels and the number of pixels vertically-arranged pixels of the light receiving surface of the imager also define a reduction ratio of a real-size, i.e. a real-scale, object to be captured by the imager.

Then, the imager of each camera 10a to 10d is configured to convert the analog pixel signals (analog pixel values) of the analog frame image into digital pixel signals (digital pixel values) based on a predetermined bit width, i.e. the number of bits, thus outputting, to the ECU 30, a digital frame image composed of two-dimensionally arranged pixels, each of which has a corresponding digital pixel value. This enables the ECU 30 to perform various image-processing tasks of the digital frame images sent from the respective cameras 10. For displaying a digital frame image on the display device 20, the ECU 30 converts the digital frame image into an analog frame image, and sends the analog frame image to the display device 20.

That is, the digital pixel value of each pixel of a digital frame image captured by a camera 10 is comprised of the predetermined number of bits that represents a corresponding luminous level and a corresponding chromaticity value based on corresponding RGB levels.

Note that each camera 10a to 10d can be configured to send, to the ECU 30, the analog frame image, and the ECU 30 can be configured to convert the analog frame image into the digital frame image.

The display device 20 includes a display 21 and a touch panel, i.e. a touch screen, 22.

The display 21 has an image display region 21a in which an image, such as an analog frame image sent from the ECU 30, is stored. The touch panel 22 is layered on the image display region 21a of the display 21. The display device 20 is arranged in the vehicle V such that a driver of the vehicle V can touch the touch screen 22 and visibly recognize information displayed on the image display region 21a.

The touch screen 22 is designed as a transparent touch-sensitive screen serving as a display-input device to display an image stored in the image display region 21a therethrough and to input information to the ECU 30 via an image displayed on the image display region 21a.

Specifically, while an image is displayed on the image display region 21a, the touch screen 22 enables a driver of the vehicle V to touch a desired location on the touch screen 22 with one or more fingers, thus entering, to the ECU 30, information based on the touched location of the corresponding displayed image.

For example, the ECU 30 is configured to transmit, to the display device 20, a start image including a visual start switch for instructing the ECU 30 to start a display routine described later. While a driver of the vehicle V can visibly recognize the start image, the driver touches, i.e. clicks, a location of the touch screen 22 corresponding to the visual start switch on in the start image. This instructs the ECU 30 to start the display routine.

The display device 20 can be shared as a display device of a navigation system installed in the vehicle V, or individually installed in the vehicle V.

The ECU 30 is for example comprised of a known microcomputer including at least a CPU 31 and a memory unit 32 including a ROM, a RAM, and a flash memory. The CPU 31 includes various functions for performing overall control of the image display system 1. Various program, i.e. program instructions, for causing the CPU 31 to perform the various functions, i.e. various routines, are stored in, for example, the ROM of the memory unit 32; the ROM serves as, for example, a non-transitory tangible storage media. In addition, various data items usable by the CPU 31 are also stored in, for example, the RAM of the memory unit 32.

The ECU 30 can be comprised of plural microcomputers, i.e. processors.

Note that at least part of all the functions provided by the ECU 30 can be implemented by at least one processor; the at least one processor can be comprised of

(1) The combination of at least one programmed processing unit, i.e. at least one programmed logic circuit, and at least one memory including software that causes the at least one programmed logic circuit to implement all the functions

(2) At least one electronic circuit, which includes at least one of a hardwired logic circuit and an analog circuit, for implementing all the functions

(3) At least one hybrid circuit, which is comprised of at least one programmable processing unit and at least one electronic circuit, for implementing all the functions

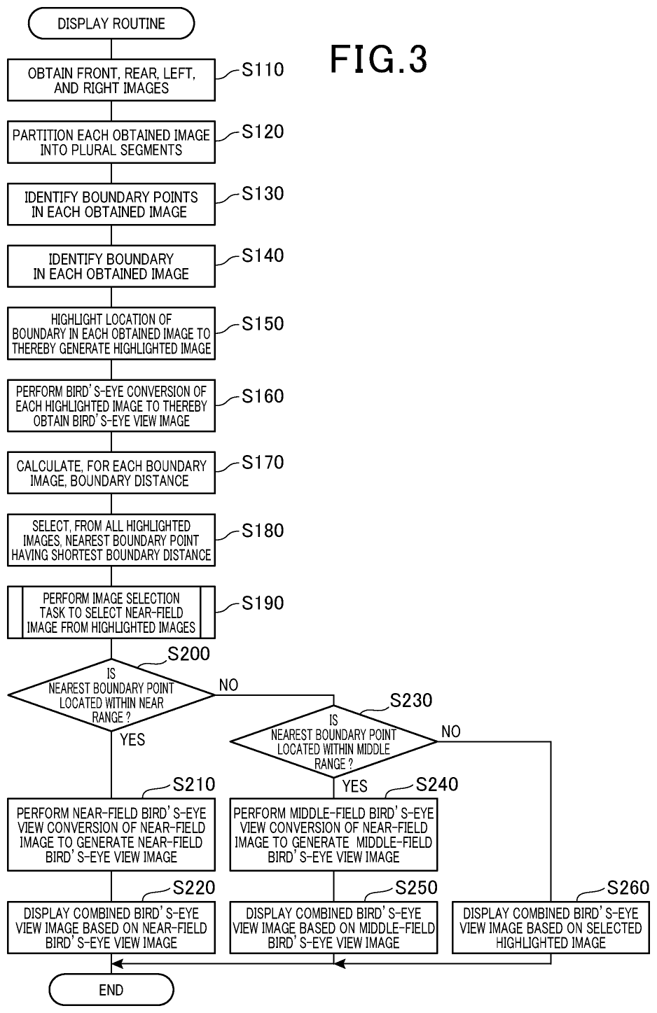

Next, the following describes the display routine carried out by the CPU 31 with reference to the flowchart of FIG. 3. That is, the CPU 31 is programmed to execute the display routine in response to a driver's touch operation of the visual start switch on the start image displayed on the image display region 21a of the display 21.

When starting the display routine, the CPU 31 serves as, for example, an image obtaining unit to obtain images, i.e. digital frame images, captured by the respective front camera 10a, rear camera 10b, left camera 10c, and right camera 10d in step S110. Specifically, the CPU 31 obtains a front image currently captured by the front camera 10a, a rear image currently captured by the rear camera 10b, a left image currently captured by the left camera 10c, and a right image currently captured by the right camera 10d in step S110. Then, the CPU 31 stores the front, rear, left, and right captured images in the memory 32.

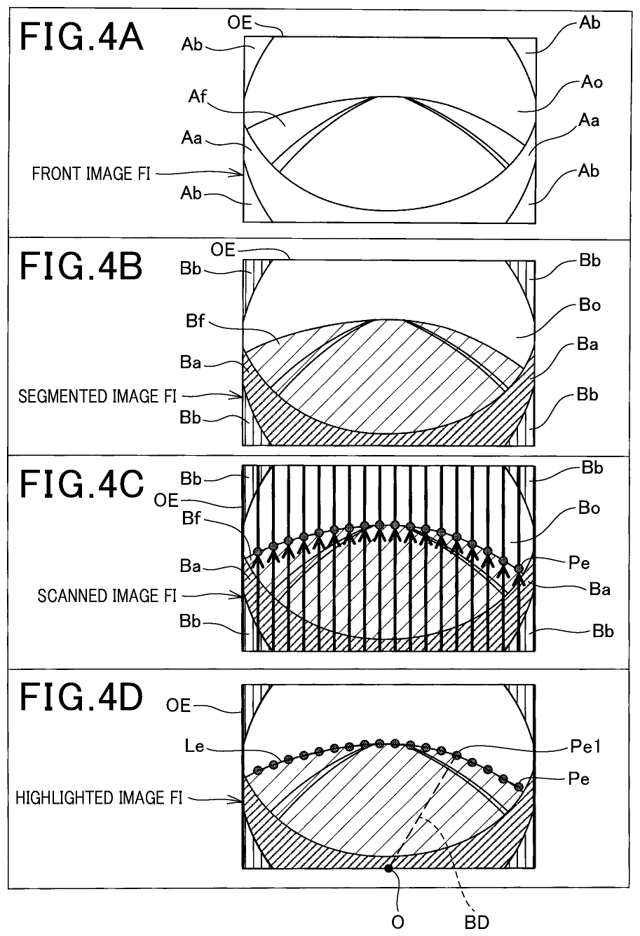

FIG. 4A schematically illustrates a front image FI captured by the front camera 10a, which is obtained by the CPU 31, as an example of images captured by the respective cameras 10a to 10d. Other rear, left, and right images can have a configuration similar to the configuration of the front image FI illustrated in FIG. 4A. FIG. 4A also illustrates the front image FI being stored in the memory 32.

As illustrated in FIG. 4A, the front image FI is a wide-angle image, which is designed to be a substantially spherical image. Reference character OE represents an outer edge of the predetermined size of a frame image captured by the front camera 10a, that is, represents an outer edge of a memory space in the memory 32 in which the front image FI is stored. Note that each camera 10 can capture an image whose configuration is identical to a normal image that is defined as an image having a predetermined normal diagonal field of view and the normal size.

FIG. 4A shows that the front image FI includes a region Aa indicative of the body of the vehicle V, regions Ab each indicative of a no-data region in the outer edge OE of the predetermined frame-image size when the frame image, i.e. wide-angle image, FI is superimposed on the normal image; the normal image has the predetermined normal diagonal field of view and the normal size. In other words, the regions Ab each represent a no-data region in the outer edge OE the memory space of the memory 32 in which the front image FI is stored.

The front image FI also includes a region Af indicative of a free travelable space of the vehicle V, and a region Ao that belongs to none of the regions Aa, Ab, and Af.

Following the operation in step S110, the CPU 31 serves as, for example, a partitioning unit to perform a known semantic segmentation task on each of the captured images obtained in step S110 to thereby divide, i.e. partition, the total region of each of the front, rear, left, and right images into plural segments; each pixel of each segment has an individual unique category label in step S120. An image subjected to the semantic segmentation task in step S120 will be referred to as a segmented image.

For simple description, the following describes how the CPU 31 performs the semantic segmentation task of the front image.

Specifically, the CPU 31 determines which class in previously defined annotation classes each pixel of the front image belongs to in accordance with the corresponding digital pixel value including the luminous level and chromaticity value, thus assigning the determined class to the corresponding pixel.

The annotation classes are associated with travelling environments around the vehicle V, and include a free space region (free space class) Bf, an own vehicle region (own vehicle class) Ba, ineffective regions (ineffective classes) Bb, and an other region (other class) Bo (see FIG. 4B).

The free space region Bf represents a road-surface region that is freely travelable for the vehicle V, and the own vehicle region Ba represents a part of the body of the vehicle V that has been seen in the front image. Each of the ineffective region Bb represents a no-data region in the outer frame of the normal image when the frame image, i.e. wide-angle image, FI is superimposed on the normal image; the normal image has the predetermined normal diagonal field of view and the normal size.

The other region Bo represents a region in the frame image FI belonging to none of the regions Ba, Bb, and Bf.

Specifically, in the memory 32 or another storage space of the ECU 30, the data set DS of the class annotations has been stored. The data set DS of the class annotations represents which of the classes (regions) each pixel should belong to in accordance with the pixel value of the corresponding pixel. The data set DS of the class annotations have been trained based on ground truth labels that associate each pixel with one of predetermined number of semantic classes. Then, the CPU 31 divides the front image FI into the regions Ba, Bb, and Bf in accordance with the class annotations of the data set DS stored in the memory 32.

That is, the CPU 31 partitions each of the front, rear, left, and right images to thereby generate a segmented image (see SEI in FIG. 4B) including the free space region Bf, own vehicle region Ba, ineffective regions Bb, and other region Bo in step S120.

Next, the CPU 31 serves as, for example, a region identifier to identify, from each of the segmented images, boundary points Pe in step S130. For simple description, the following describes how the CPU 31 performs the boundary point extracting operation for the segmented image generated based on the front image, which will be referred to as a front segmented image, in step S130.

Specifically, in step S130, the CPU 31 vertically scans, pixel by pixel, each row of the front segmented image from its lowest pixel to its highest pixel to thereby identify, as the boundary points Pe, points of a boundary between

(1) Edge pixels of the free space region Bf that serves as a travelable region

(2) Edge pixels of the remaining region except for the travelable region, which are respectively adjacent to the edge pixels of the travelable region

The remaining region except for the travelable region serves as non-travelable region. The segmented image from which the boundary points Pe have been identified will be referred to as a scanned image (see SCI in FIG. 4C).

Subsequently, the CPU 31 serves as, for example, a boundary identifier that identifies, in each of the scanned images, a boundary Le between the travelable region and the non-travelable region in step S140. Specifically, the CPU 31 identifies the location of a line connecting the identified boundary points Pe as the boundary Le in step S140.

Following the operation in step S140, the CPU 31 serves as, for example, a highlighting unit that recognizes the location of the boundary Le identified from each of the scanned images, and highlights the recognized location of the boundary Le in the corresponding one of the captured images obtained in step S120, thus generating highlighted images for the respective cameras 10a to 10d in step S150. FIG. 4D schematically illustrates such a highlighted image HI based on the front image FI.

For example, the CPU 31 superimposes a highlighted line marker on the location of the boundary Le in each of the captured images, i.e. each of the front, rear, left, and right images, thus generating the highlighted images for the respective cameras 10a to 10d.

Note that the CPU 31 can highlight the recognized location of the boundary Le in each of the captured images obtained in step S120 using one of various measures. For example, the CPU 31 can superimpose a travelable-region highlighted image on the travelable region of each of the captured images obtained in step S120. The travelable-region highlighted image is configured such that a predetermined unique chromaticity value, which shows a predetermined distinguishable unique color in each captured image, is stored in each pixel of the travelable region. This therefore results in the color of the travelable region displayed on the display region 21a of the display 21 being distinguished from the color of the non-travelable region. The color of the travelable region is, for example, a display mode of the travelable region.

For example, if there are columnar obstacles and/or wall-structure obstacles in a region of the front image so that the region is recognized as the non-travelable region, a predetermined unique chromaticity value, which shows a predetermined distinguishable unique color in each captured image, is not stored in each pixel of the non-travelable region.

As another example, the CPU 31 can superimpose a non-travelable region highlighted image on the non-travelable region of each of the captured images obtained in step S120. The non-travelable region highlighted image is configured such that a predetermined unique chromaticity value, which shows a predetermined distinguishable unique color in each captured image, is stored in each pixel of the non-travelable region. This therefore results in the color of the non-travelable region displayed on the display region 21a of the display 21 being distinguished from the color of the travelable region. The color of the non-travelable region is, for example, a display mode of the non-travelable region.

As a further example, the CPU 31 can superimpose at least two of the highlighted line marker, the travelable region highlighted image, and the non-travelable region highlighted image on the corresponding two of the location of the boundary Le, the travelable region, and the non-travelable region in each of the captured images.

In particular, the CPU 31 can superimpose the travelable region highlighted image and the non-travelable region highlighted image on the respective travelable region and non-travelable region in each of the captured images while a first display mode of the travelable region, such as a chromaticity value stored in each pixel of the travelable region, can be distinguished from a second display mode of the non-travelable region, such as a second chromaticity value stored in each pixel of the non-travelable region.

That is, the CPU 31 can cause the first display mode of the travelable region, which includes at least one of the color of the travelable region, the luminance of the travelable region, and flashing or non-flashing of the travelable region, to be different from the corresponding second display mode of the non-travelable region.

Hereinafter, the highlighted images corresponding to the front, rear, left, and right images will be referred to respectively as front highlighted image, rear highlighted image, left highlighted image, and right highlighted image.

Following the operation in step S150, the CPU 31 serves as, for example, a bird's-eye view conversion unit that performs bird's-eye view conversion of each of the front, rear, left, and right highlighted images to thereby obtain a corresponding one of front, rear, left, and right converted images in step S160. Then, the CPU 31 combines the front, rear, left, and right converted images with each other to thereby obtain a collective bird's-eye view image 300 in step S160.

The collective bird's-eye view image 300 obtained in step S160 shows an image of a road surface around the vehicle V viewed from a virtual camera located above the vehicle V.

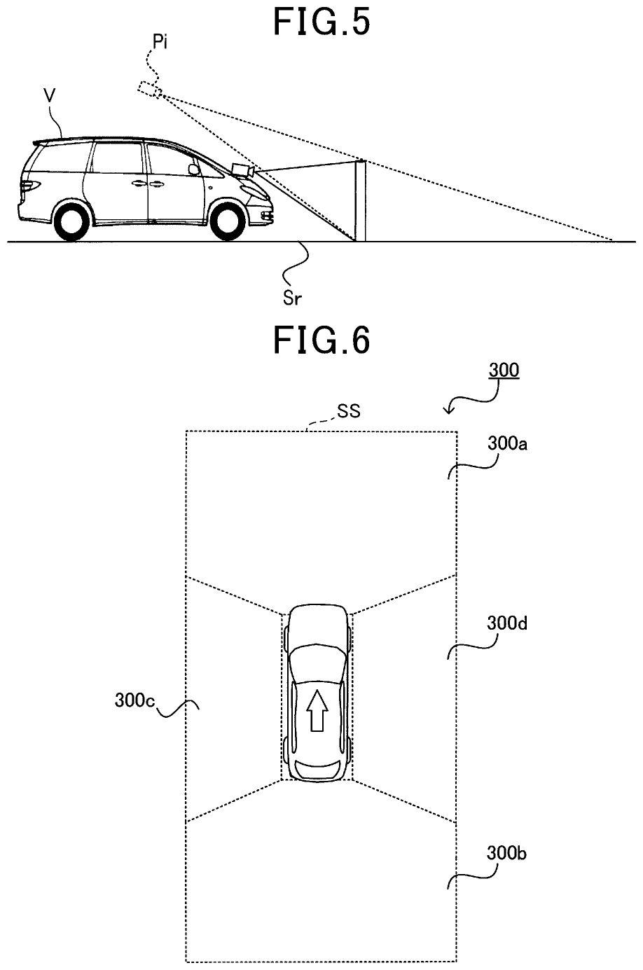

Specifically, for performing the bird's-eye view conversion of, for example, the front highlighted image in step S160, the CPU 31 for example converts the coordinates of each pixel of the front highlighted image into coordinates of a corresponding pixel of a projected image on a plane, i.e. a road-surface projection plane Sr, on which the vehicle V exists such that the projected image, i.e. the front converted image, on the road-surface projection plane Sr shows an image viewed from a virtual camera Pi located above the vehicle V (see FIG. 5).

That is, the front converted image shows a front region on the road-surface projection plane Sr with respect to the vehicle V.

The other rear, left, and right highlighted images can be converted into the rear, left, and right converted images in the same approach as conversion of the front highlighted image into the front converted image set forth above.

Hereinafter, the front, rear, left, and right converted images obtained by the bird's-eye view conversion of the respective front, rear, left, and right highlighted images will also be referred to respectively as front, rear, left and right bird's-eye view images 300a, 300b, 300c, and 300d. Note that the front, rear, left and right bird's-eye view images 300a, 300b, 300c, and 300d can also be referred to respective as individual bird's-eye view images 300a, 300b, 300c, and 300d.

That is, the front, rear, left, and right bird's-eye view images 300a, 300b, 300c, and 300d respectively correspond to front, rear, left, right regions on the road-surface projection plane Sr with respect to the vehicle V.

In step S160, the CPU 31 allocates a predetermined-sized storage space SS in the memory 32, and stores a vehicular image VI showing an image of the vehicle V in the center of the storage space SS; the size of the storage space SS corresponds to the size of the display region 21a of the display 21.

Then, the CPU 31 stores the front, rear, left, and right bird's-eye view images 300a, 300b, 300c, and 300d in respective front, rear, left, and right regions in the storage space SS with respect to the vehicular image VI, thus combining the front, rear, left, and right bird's-eye view images 300a, 300b, 300c, and 300d with each other in the storage space SS in step S160 (see FIG. 6). This results in the collective bird's-eye view image 300 being obtained in the storage space SS of the memory 32.

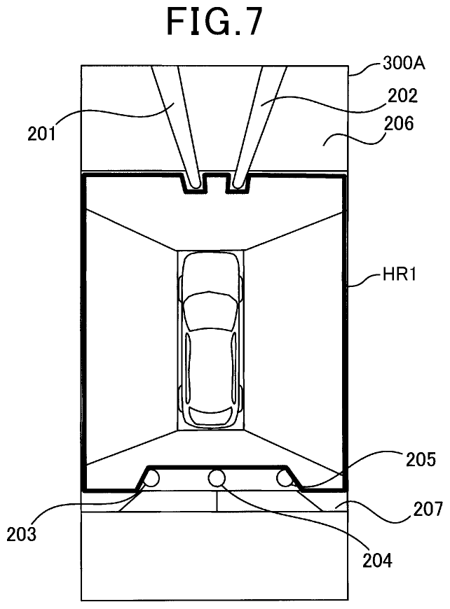

Because each of the bird's-eye view images 300a, 300b, 300c, and 300d is generated based on the corresponding one of the highlighted images, the collective bird's-eye view image 300 includes a highlighted region. For example, as illustrated in FIG. 7, a collective bird's-eye view image 300A generated by the CPU 31 includes a substantially rectangular-frame highlighted region HR1 that is illustrated by a predetermined-colored heavy line when the collective bird's-eye view image 300A is displayed on the display region 21a of the display 21.

As a first example illustrated in FIG. 7, the highlighted region HR1 included in the collective bird's-eye view image 300A is a highlighted line marker on the location of the boundary Le including the identified boundary points Pe.

This enables the highlighted region HR1 to partition a travelable area enclosed in the highlighted region HR1 and a non-travelable area, which includes columnar obstacles 201 to 205 and wall-structure obstacles 206 and 207, located outside the highlighted region HR1.

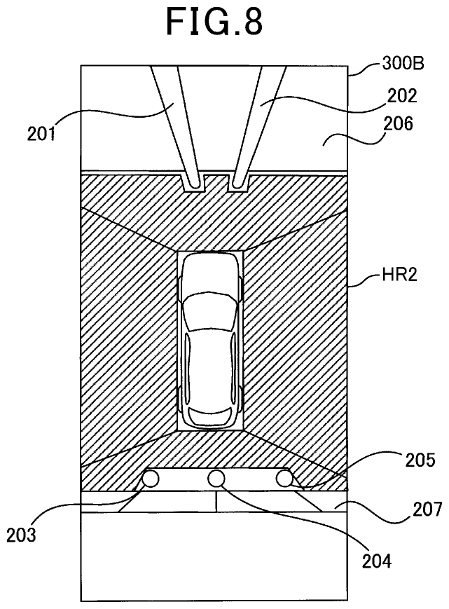

As a second example, as illustrated in FIG. 8, a highlighted region HR2 included in a collective bird's-eye view image 300B generated by the CPU 31 is the travelable-region highlighted image superimposed on the travelable region in the collective bird's-eye view image 300B.

This enables the travelable area enclosed by the highlighted region HR2 to be filled with a predetermined distinguishable unique color when the collective bird's-eye view image 300B is displayed on the display region 21a of the display 21. In other words, this enables the non-travelable area, which includes columnar obstacles 201 to 205 and wall-structure obstacles 206 and 207, located outside the highlighted region HR2 not to be filled with the predetermined distinguishable unique color.

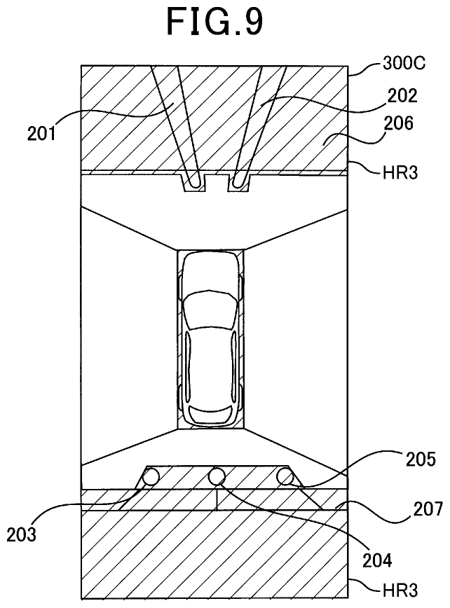

As a third example, as illustrated in FIG. 9, a highlighted region HR3 included in a collective bird's-eye view image 300C generated by the CPU 31 is the non-travelable region highlighted image superimposed on the non-travelable region in the collective bird's-eye view image 300C.

This enables the non-travelable area enclosed by the highlighted region HR3, which includes columnar obstacles 201 to 205 and wall-structure obstacles 206 and 207, to be filled with a predetermined distinguishable unique color when the collective bird's-eye view image 300C is displayed on the display region 21a of the display 21. In other words, this enables the travelable area located outside the highlighted region HR3 not to be filled with the predetermined distinguishable unique color.

That is, as described above, at least two of the highlighted line marker, the travelable region highlighted image, and the non-travelable region highlighted image can be superimposed on the corresponding two of the location of the boundary Le, the travelable region, and the non-travelable region in each of the captured images, the at least two of the highlighted line marker. In this example, at least two of the travelable region highlighted image, and the non-travelable region highlighted image can be viewed by a driver when the corresponding bird's-eye view image 300 is displayed on the display region 21a of the display 21. The travelable region highlighted image and the non-travelable region highlighted image can be displayed while a first unique color filled in the travelable region highlighted image and a second unique color filled in the non-travelable region can be visibly distinguished from each other.

In step S170 subsequent to step S160, the CPU 31 serves as, for example, a distance calculating unit that calculates, for each of the highlighted images, a boundary distance for each boundary point Pe. The boundary distance for each boundary point Pe for, for example, the front image or front highlighted image is defined as a minimum distance between a predetermined origin and the corresponding boundary point Pe; the origin is defined as a center of the bottom edge of the front image of front highlighted image, which corresponds to, for example, a predetermined position of the vehicle in the front highlighted image. For example, FIG. 4D schematically illustrates an example of such a boundary distance (see reference character BD) between a selected boundary point Pe1 and the origin O for the highlighted image HI.

In step S180 subsequent to step S170, the CPU 31 selects, from all the captured images or highlighted images, at least one of the boundary points Pe as at least one nearest boundary point Np; the at least one nearest boundary point Np has the shortest boundary distance in all the boundary points Pe.

In step S180, if the CPU 31 cannot detect at least one nearest boundary point Np from all the captured images or highlighted images, the display routine proceeds to step S190

Next, the CPU 31 performs the following operations in steps S190 to S260 to thereby generate a particular interest image, i.e. a priority image, thus instructing the display 21 to display the particular interest image on the display region 21a. Such a particular interest image is defined as an image that is displayed on the display region 21a together with the bird's-eye view image 300, and that is configured to enable a driver of the vehicle V to visibly recognize a relative positional relationship between the at least one nearest boundary point Np and the vehicle V.

In particular, the CPU 31 serves as, for example, a particular interest image generator to perform the following operations in steps S190 to S210 and S230 to S240. The CPU 31 serves as, for example, an image display unit or a particular interest image display unit that performs the operations in steps S220, S250, and S260, and serves as, for example, an adjuster that performs operations in steps S210 and S240.

Specifically, the CPU 31 performs an image selection task to select, based on the at least one nearest boundary point Np, a near-field image from the front, rear, left, and right highlighted images in step S190; the near-field image is one of

(1) The front or rear highlighted image corresponding to the travelling direction of the vehicle V

(2) The left highlighted image

(3) The right highlighted image

How the CPU 31 performs the image selection task to select, based on the at least one nearest boundary point Np, the near-field image will be described in detail later.

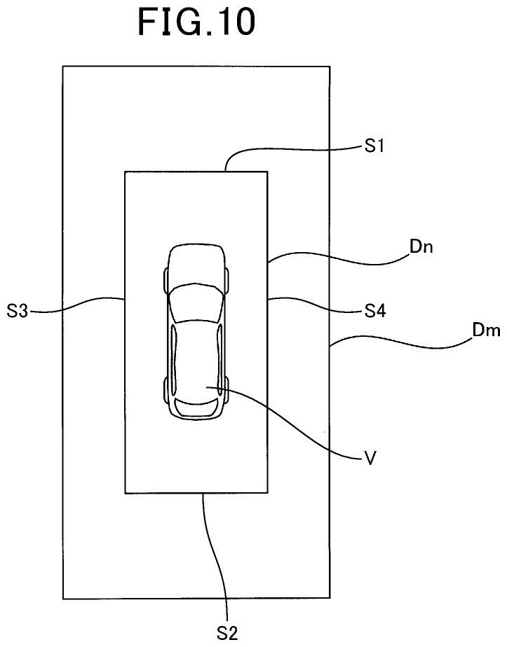

Next, the CPU 31 determines whether the at least one nearest boundary point Np is located within a predetermined near range Dn in the near-field image; the near range Dn is defined around the vehicle V in step S200. FIG. 10 schematically illustrates an example of the near range Dn defined around the vehicle V in the near-field image. The near range Dn is defined for detecting, for example, obstacles located around the vehicle V.

For example, a real-scale near range corresponding to the near range Dn is defined to have a rectangular shape and located such that the center of the real-scale vehicle V matches the center of the rectangular real-scale near range; the rectangular real-scale near range has

(1) A front side with a minimum distance of 2 meters relative to the front end of the real-scale vehicle V

(2) A rear side with a minimum distance of 2 meters relative to the rear end of the real-scale vehicle V

(3) A left side with a minimum distance of 1 meter relative to the left side of the real-scale vehicle V

(4) A right side with a minimum distance of 1 meter relative to the right side of the real-scale vehicle V

Assuming that the reduction ratio of the imager of each camera 10 is referred to as a reduction ratio RR, the near range Dn is defined to have a rectangular shape and located such that the center of the vehicle V matches the center of the near range Dn; the rectangular near range Dn has

(1) A front side S1 with a minimum distance of 2×R m relative to the front end of the vehicle V

(2) A rear side S2 with a minimum distance of 2×R m relative to the rear end of the vehicle V

(3) A left side S3 with a minimum distance of 1×R m relative to the left side of the vehicle V

(4) A right side S4 with a minimum distance of 1×R m relative to the right side of the real-scale vehicle V

Note that the near range Dn is not limited to the shape and/or size, and can be designed to have any shape and any size, which enables obstacles around the vehicle V to be detected.

Upon determination that the at least one nearest boundary point Np is located within the near range Dn in the near-field image (YES in step S200), the display routine proceeds to step S210.

In step S210, the CPU 31 performs a near-field bird's-eye view conversion of the near-field image selected in step S190 to thereby convert the near-field image into a near-field bird's-eye view image. The near-field bird's-eye view conversion of the near-field image is defined as modified bird's-eye view conversion.

That is, the near-field bird's-eye view conversion of the near-field image converts coordinates of each pixel of the near-field image into coordinates of the corresponding pixel of an enlarged projected image on the road-surface projection plane Sr such that the enlarged projected image, i.e. the near-field bird's-eye view image, on the road-surface projection plane Sr shows an image viewed from a virtual camera Pi that

(1) Lies at a predetermined position above the vehicle V, which enables an optical axis thereof to be directed toward the real-scale near range

(2) Covers the corresponding near range Dn from the end of the vehicle V corresponding to the near-field image

An example of the near-field bird's-eye view image generated in step S210 will be described later.

Subsequent to step S210, the CPU 31 instructs the display 21 to display the near-field bird's-eye view image, which serves as a particular interest image, and the collective bird's-eye view image 300 obtained in step

S160 on the display region 21a together with each other in step S220; the combination of the near-field bird's-eye view image and the collective bird's-eye view image 300 constitute the combined bird's-eye view image. The CPU 31 thereafter terminates the display routine.

The CPU 31 can be configured to send, to the cruise assist controller 25, the combined bird's-eye view image in step S220. This enables the cruise assist controller 25 to control automatic cruising or a driver's cruising of the vehicle V in accordance with the combined bird's-eye view image sent from the CPU 31 and vehicle condition information and environmental condition information sent from external devices ED (see FIG. 1).

The external devices ED include sensors installed in the vehicle V, wireless communication devices installed in other vehicles located around the vehicle V, road infrastructural devices provided on roads, and/or wireless information centers provided by public or private organizations. The vehicle condition information represents how and where the vehicle V is travelling, and the environmental condition information represents environmental conditions around the vehicle V.

Otherwise, upon determination that the nearest boundary point Np is not located within the near range Dn in the near-field image (NO in step S200), the display routine proceeds to step S230.

In step S230, the CPU 31 determines whether the at least one nearest boundary point Np is located within a predetermined middle range Dm in the near-field image; the middle range Dm is defined around the vehicle V. FIG. 10 schematically illustrates an example of the middle range Dm defined around the vehicle V in the near-field image. The middle range Dm is defined for detecting, for example, pedestrians walking around the vehicle V.

For example, a real-scale middle range corresponding to the middle range Dm is defined to have a rectangular shape and located such that the center of the real-scale vehicle V matches the center of the rectangular real-scale middle range; the rectangular real-scale middle range has

(1) A front side with a minimum distance within the range from 2 to 10 meters inclusive relative to the front end of the real-scale vehicle V

(2) A rear side with a minimum distance within the range from 2 to 10 meters inclusive relative to the rear end of the real-scale vehicle V

(3) A left side with a minimum distance within the range from 1 to 5 meters relative to the left side of the real-scale vehicle V

(4) A right side with a minimum distance within the range from 1 to 5 meters relative to the right side of the real-scale vehicle V

Like the near range Dn, the middle range Dm is defined to have a rectangular shape and located such that the center of the vehicle V matches the center of the middle range Dm in accordance with the reduction ratio RR; the rectangular middle range Dm has

(1) A front side S11 with a minimum distance within the range from 2×R meters to 10×R meters relative to the front end of the vehicle V

(2) A rear side S2 with a minimum distance within the range from 2×R meters to 10×R meters relative to the rear end of the vehicle V

(3) A left side S3 with a minimum distance within the range from 1×R meters to 5×R meters relative to the left side of the vehicle V

(4) A right side S4 with a minimum distance within the range from 1×R meters to 5×R meters relative to the right side of the real-scale vehicle V

Note that the middle range Dm is not limited to the shape and/or size, and can be designed to have any shape and any size, which enables pedestrians walking around the vehicle V to be detected.

Upon determination that the at least one nearest boundary point Np is located within the middle range Dm in the near-field image (YES in step S230), the display routine proceeds to step S240.

In step S240, the CPU 31 performs a middle-field bird's-eye view conversion of the near-field image selected in step S190 to thereby convert the near-field image into a middle-field bird's-eye view image. The middle-field bird's-eye view conversion of the near-field image is defined as modified bird's-eye view conversion.

That is, the middle-field bird's-eye view conversion of the near-field image converts the near-field image into an enlarged projected image on the road-surface projection plane Sr such that the enlarged projected image, i.e. the middle-field bird's-eye view image, on the road-surface projection plane Sr shows an image viewed from a virtual camera Pi that

(1) Lies at a predetermined position above the vehicle V, which enables an optical axis thereof to be directed to have an inclination of, for example, substantially 45 degrees with respect to the vertically downward direction toward the near-field image

(2) Covers the corresponding middle range Dm

An example of the middle-field bird's-eye view image generated in step S240 will be described later.

Subsequent to step S240, the CPU 31 instructs the display 21 to display the middle-field bird's-eye view image as a particular interest image, and the collective bird's-eye view image 300 obtained in step S160 on the display region 21a together with each other in step S250; the combination of the middle-field bird's-eye view image and the collective bird's-eye view image 300 constitute the combined bird's-eye view image. The CPU 31 thereafter terminates the display routine.

Otherwise, upon determination that the at least one nearest boundary point Np is not located within the middle range Dm (NO in step S230), the display routine proceeds to step S260.

In step S260, the CPU 31 instructs the display 21 to display a selected one of the highlighted images, which highlights the recognized location of the boundary Le, and the collective bird's-eye view image 300 obtained in step S160 on the display region 21a together with each other; the combination of the selected highlight image and the collective bird's-eye view image 300 constitute the combined bird's-eye view image. The CPU 31 thereafter terminates the display routine.

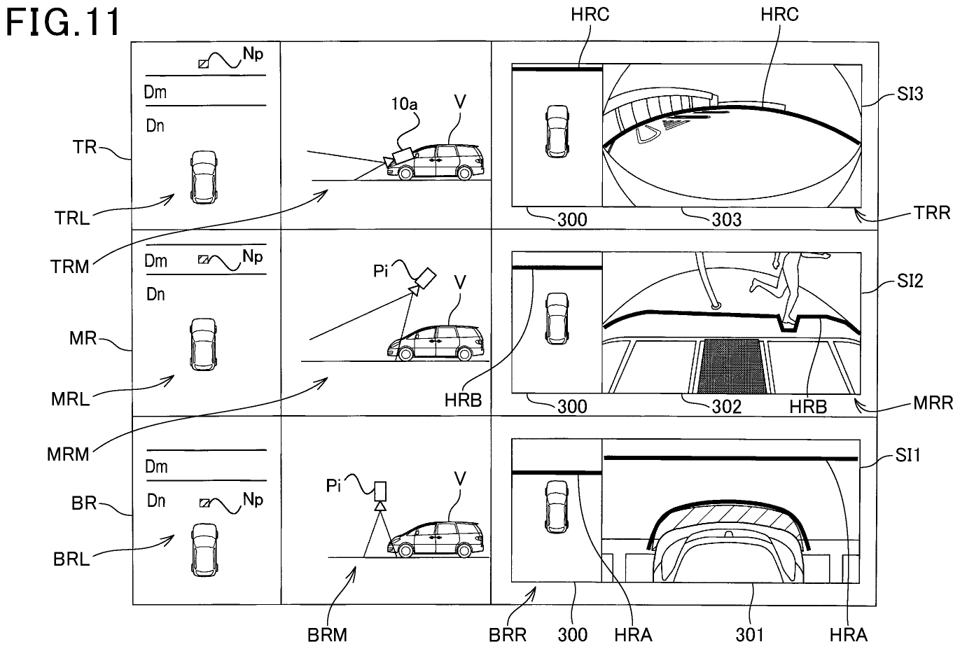

Next, the following describes an example of the combined bird's-eye view image generated by the CPU 31 and displayed on the display region 21a of the display 21 when the front highlighted image is selected as the near-field image in step S190 with reference to FIG. 11. Note that FIG. 11 for example schematically illustrates first to third examples of the combined bird's-eye view image using a table format.

Specifically, the table illustrated in FIG. 11 is comprised of bottom, middle, and top rows BR, MR, and TR.

The bottom row BR of FIG. 11, which has right, middle, and left cells BRR, BRM, and BRL, schematically illustrates the first example of the combined bird's-eye view image SI1 (see the right cell BRR) upon the at least one nearest boundary point Np being within the narrow range Dn (see the left cell BRL) and the virtual camera Pi having a predetermined arrangement (see the middle cell BRM) that

(1) Lies at a predetermined position above the front end of the vehicle V or therearound, which enables the optical axis thereof to be directed toward the real-scale near range, i.e. the front real-scale near range

(2) Covers the corresponding near range Dn from the front end of the vehicle V corresponding to the near-field image

Specifically, when the at least one nearest boundary point Np is within the narrow range Dn (see the left cell BRL), the virtual camera Pi lies above the vehicle V at 1 meter distance before the front end of the vehicle V, which enables the optical axis to be directly downward toward the near range Dn.

As described above, converting coordinates of each pixel of the near-field image into coordinates of the corresponding pixel of an enlarged projected image on the road-surface projection plane Sr such that the enlarged projected image, i.e. the near-field bird's-eye view image, which is viewed from the virtual camera Pi, covers a rectangular range, which at least extends 2 meters distance from the front end of the vehicle V, on the road-surface projection plane Sr.

This results in the near-field bird's-eye view image, which serves as a particular interest image (see reference character 301 in FIG. 11), and the collective bird's-eye view image 300 being displayed at respective right and left portions of the display region 21a of the display 21 together with each other as the combined bird's-eye view image SI1 (see FIG. 11).

That is, each of the collective bird's-eye view image 300 and near-field bird's-eye image 301 includes a highlighted region HRA for visibly highlighting the boundary between the travelable and non-travelable regions.

The middle row MR of FIG. 11, which has right, middle, and left cells MRR, MRM, and MRL, schematically illustrates the second example of the combined bird's-eye view image SI2 (see the right cell MRR) upon the at least one nearest boundary point Np being within the middle range Dm (see the left cell MRL) and the virtual camera Pi having a predetermined arrangement (see the middle cell MRM) that

(1) Lies at a predetermined position above the vehicle V, which enables an optical axis thereof to be directed to have an inclination of, for example, substantially 45 degrees with respect to the vertically downward direction toward the front direction

(2) Covers the corresponding middle range Dm

Specifically, when the at least one nearest boundary point Np is within the middle range Dm (see the left cell MRL), the virtual camera Pi lies above the vehicle V such that its optical axis is directed to be inclined by 45 degrees with respect to the vertically downward direction toward the front direction.

As described above, converting coordinates of each pixel of the near-field image into coordinates of the corresponding pixel of an enlarged projected image on the road-surface projection plane Sr such that the enlarged projected image, i.e. the near-field bird's-eye view image, which is viewed from the virtual camera Pi, covers a rectangular range, which is located to be within at least the range from 2 to 10 meters inclusive before the front end of the vehicle V, on the road-surface projection plane Sr.

This results in the near-field bird's-eye view image (see reference character 302 in FIG. 11) and the collective bird's-eye view image 300 being displayed at respective right and left portions of the display region 21a of the display 21 together with each other as the combined bird's-eye view image SI2 (see FIG. 11).

That is, each of the collective bird's-eye view image 300 and near-field bird's-eye image 302 includes a highlighted region HRB for visibly highlighting the boundary between the travelable and non-travelable regions.

The top row TR of FIG. 11, which has right, middle, and left cells TRR, TRM, and TRL, schematically illustrates the third example of the combined bird's-eye view image SI3 (see the right cell TRR) upon the at least one nearest boundary point Np being outside the near and middle ranges Dr and Dm (see the left cell TRL) and the left highlighted image captured by the left camera 10c being used (see the middle cell TRM).

This results in the front highlighted image (see reference character 303 in FIG. 11) and the collective bird's-eye view image 300 being displayed at respective right and left portions of the display region 21a of the display 21 together with each other as the combined bird's-eye view image SI3 (see FIG. 11).

That is, each of the collective bird's-eye view image 300 and front highlighted image 303 includes a highlighted region HRC for visibly highlighting the boundary between the travelable and non-travelable regions.

How the three patterns SI1 to SI3 of the combined bird's-eye view image generated by the CPU 31 are displayed on the display region 21a of the display 21 when the front highlighted image is selected as the near-field image in step S190 with reference to FIG. 11.

When the rear highlighted image is selected as the near-field image in step S190, three patterns of the combined bird's-eye image based on the near-field image (rear highlighted image) can be displayed in the same manner as the combined bird's-eye view image illustrated in FIG. 11 as long as the front-rear direction in FIG. 11 is reversed.

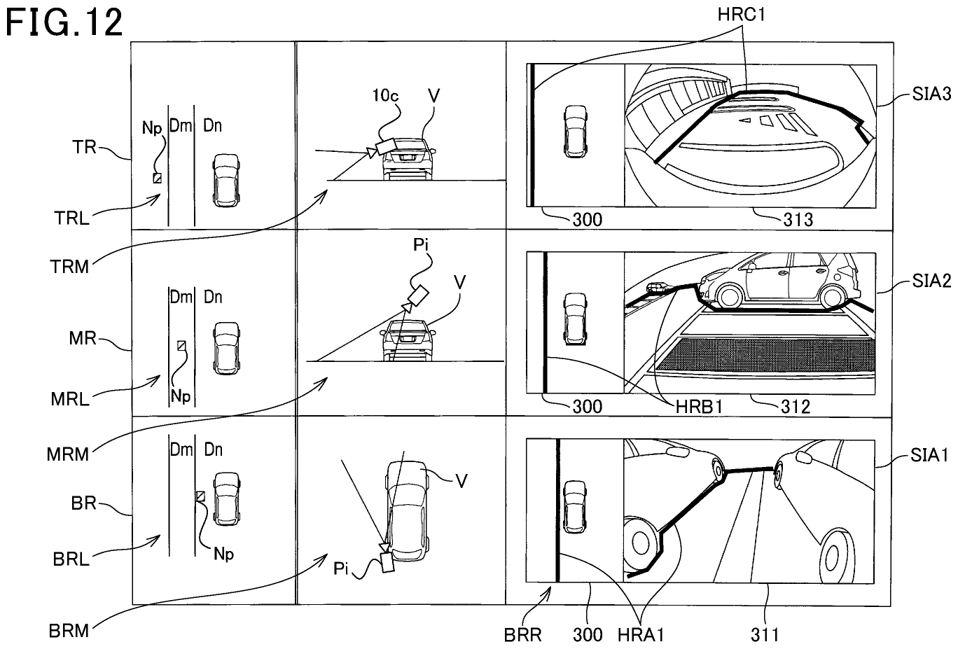

Next, the following describes an example of the combined bird's-eye view image generated by the CPU 31 and displayed on the display region 21a of the display 21 when the left highlighted image is selected as the near-field image in step S190 with reference to FIG. 12. Note that FIG. 12 for example schematically illustrates first to third examples of the combined bird's-eye view image using a table format.

Specifically, the table illustrated in FIG. 12 is comprised of bottom, middle, and top rows BR, MR, and TR.

The bottom row BR of FIG. 12, which has right, middle, and left cells BRR, BRM, and BRL, schematically illustrates the first example of the combined bird's-eye view image SIA1 (see the right cell BRR) upon the at least one nearest boundary point Np being within the narrow range Dn (see the left cell BRL) and the virtual camera Pi having a predetermined arrangement (see the middle cell BRM) that

(1) Lies at a predetermined position above the vehicle V, which enables the optical axis thereof to be directed toward the real-scale near range, i.e. the left real-scale near range

(2) Covers the corresponding near range Dn from the end of the vehicle V corresponding to the near-field image

Specifically, when the at least one nearest boundary point Np is within the narrow range Dn (see the left cell BRL), the virtual camera Pi lies above the left-rear end of the vehicle V, which enables the optical axis to be directed toward the left-front end of the vehicle V, thus enabling the optical axis to be directed toward the near range Dn.

As described above, converting coordinates of each pixel of the near-field image into coordinates of the corresponding pixel of an enlarged projected image on the road-surface projection plane Sr such that the enlarged projected image, i.e. the near-field bird's-eye view image, which is viewed from the virtual camera Pi, covers a rectangular range, which at least has 1 meter distance before the left side end of the vehicle V, on the road-surface projection plane Sr.

This results in the near-field bird's-eye view image as a particular interest image (see reference character 311 in FIG. 12) and the collective bird's-eye view image 300 being displayed at respective right and left portions of the display region 21a of the display 21 together with each other as the combined bird's-eye view image SIA1 (see FIG. 12).

That is, each of the collective bird's-eye view image 300 and near-field bird's-eye image 311 includes a highlighted region HRA1 for visibly highlighting the boundary between the travelable and non-travelable regions.

The middle row MR of FIG. 12, which has right, middle, and left cells MRR, MRM, and MRL, schematically illustrates the second example of the combined bird's-eye view image SIA2 (see the right cell MRR) upon the at least one nearest boundary point Np being within the middle range Dm (see the left cell MRL) and the virtual camera Pi having a predetermined arrangement (see the middle cell MRM) that

(1) Lies at a predetermined position above the vehicle V, which enables an optical axis thereof to be directed toward the left direction to have an inclination of, for example, substantially 45 degrees with respect to the vertically downward direction toward the front direction

(2) Covers the corresponding middle range Dm

Specifically, when the at least one nearest boundary point Np is within the middle range Dm (see the left cell MRL), the virtual camera Pi lies above the vehicle V such that its optical axis is directed toward the left direction to be inclined by 45 degrees with respect to the vertically downward direction toward the front direction.

As described above, converting coordinates of each pixel of the near-field image into coordinates of the corresponding pixel of an enlarged projected image on the road-surface projection plane Sr such that the enlarged projected image, i.e. the middle-field bird's-eye view image, which is viewed from the virtual camera Pi, covers a rectangular range, which is located to be within at least the range from 2 to 10 meters inclusive before the front end of the vehicle V, on the road-surface projection plane Sr.

This results in the middle-field bird's-eye view image as a particular interest image (see reference character 312 in FIG. 12) and the collective bird's-eye view image 300 being displayed at respective right and left portions of the display region 21a of the display 21 together with each other as the combined bird's-eye view image SIA2 (see FIG. 12).

That is, each of the collective bird's-eye view image 300 and middle-field bird's-eye image 312 includes a highlighted region HRB1 for visibly highlighting the boundary between the travelable and non-travelable regions.

The top row TR of FIG. 12, which has right, middle, and left cells TRR, TRM, and TRL, schematically illustrates the third example of the combined bird's-eye view image SIA3 (see the right cell TRR) upon the at least one nearest boundary point Np being outside the near and middle ranges Dr and Dm (see the left cell TRL) and the left highlighted image captured by the left camera 10c being used (see the middle cell TRM).

This results in the left highlighted image (see reference character 313 in FIG. 12) and the collective bird's-eye view image 300 being displayed at respective right and left portions of the display region 21a of the display 21 together with each other as the combined bird's-eye view image SIA3 (see FIG. 12).

That is, each of the collective bird's-eye view image 300 and left highlighted image 313 includes a highlighted region HRC1 for visibly highlighting the boundary between the travelable and non-travelable regions.

How the three patterns SIA1 to SIA3 of the combined bird's-eye view image generated by the CPU 31 are displayed on the display region 21a of the display 21 when the left highlighted image is selected as the near-field image in step S190 with reference to FIG. 12.

When the right highlighted image is selected as the near-field image in step S190, three patterns of the combined bird's-eye image based on the near-field image (right highlighted image) can be displayed in the same manner as the combined bird's-eye view image illustrated in FIG. 12 as long as the left-right direction in FIG. 12 is reversed.

For example, each of the highlighted line marker, the travelable region highlighted image, and the non-travelable region highlighted image serves as, for example, a range highlighted image.

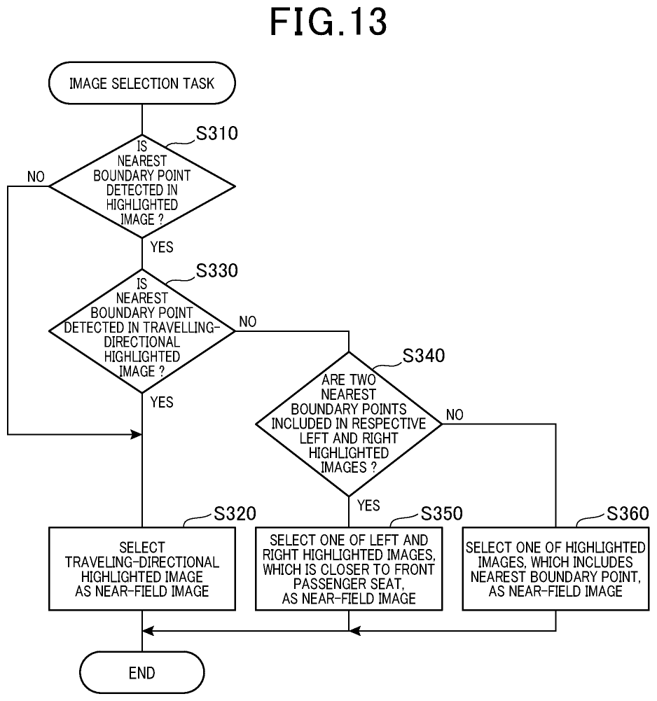

Next, the following describes how the CPU 31 performs the image selection task in step S190 with reference to a subroutine (see FIG. 13) of the main display routine of FIG. 3.

Specifically, the CPU 31 determines whether at least one nearest boundary point Np is detected in at least one of the front, rear, left, and right highlighted images in step S310.

Upon determination that no nearest boundary points Np are detected in all the front, rear, left, and right highlighted images (NO in step S310), the subroutine proceeds to step S320.

In step S320, the CPU 31 selects, from the front and rear highlighted images, a travelling-directional highlighted image that is

(1) The front highlighted image when the vehicle V is travelling in the front direction

(2) The rear highlighted image when the vehicle V is travelling in the rear direction

Then, the CPU 31 sets the selected one of the front and rear images as the near-field image in step S320.

For example, if the vehicle V is travelling in the front direction, the CPU 31 selects, from the front and rear highlighted images, the front highlighted image as the travelling-directional highlighted image, thus setting the travelling-directional highlighted image as the near-field image in step S320. As another example, if the vehicle V is travelling in the rear direction, the CPU 31 selects, from the front and rear highlighted images, the rear highlighted image as the travelling-directional highlighted image, thus setting the travelling-directional highlighted image as the near-field image in step S320.

The CPU 31 can determine whether the vehicle V is travelling in the front direction or rear direction in a selected one of known various methods.

For example, the external device ED includes a shift lever that enables a driver of the vehicle V to select any one of drive modes of the vehicle V, which include, for example, a drive mode, i.e. a drive range, (D) and a revere mode, i.e. a reverse range, (R). Shifting the shift lever to the drive mode enables the vehicle V to travel in the front direction, and shifting the shift lever to the reverse mode enables the vehicle V to travel in the rear direction.

That is, the CPU 31 can determine whether the vehicle V is travelling in the front direction or rear direction in accordance with the selected position of the shift lever in step S320.

After selection of one of the front and rear highlighted images as the near-field image, the CPU 31 terminates the subroutine, and returns to step S200 of the main display routine.

Otherwise, upon determination that at least one nearest boundary point Np is detected in one of the front, rear, left, and right highlighted images (YES in step S310), the subroutine proceeds to step S330.

In step S330, the CPU 31 determines whether the detected at least one nearest boundary point Np is included in the travelling-directional highlighted image that is

(1) The front highlighted image when the vehicle V is travelling in the front direction

(2) The rear highlighted image when the vehicle V is travelling in the rear direction

Like the operation in step S320, the CPU 31 can determine whether the vehicle V is travelling in the front direction or rear direction, and select one of the front and rear highlighted images as the travelling-directional highlighted image in accordance with a result of the determination, thus determining whether the detected at least one nearest boundary point Np is included in the travelling-directional highlighted image in step S330.

Upon determination that the detected at least one nearest boundary point Np is included in the travelling-directional highlighted image (YES in step S330), the CPU 31 performs the operation in step S320 to thereby set the travelling-directional highlighted image as the near-field image, and thereafter, terminating the display routine.

Otherwise, upon determination that the detected at least one nearest boundary point Np is not included in the travelling-directional highlighted image (NO in step S330), the subroutine proceeds to step S340.

In step S340, the CPU 31 determines whether

(1) The detected at least one nearest boundary point Np is two or more consists of at least two nearest boundary points Np

(2) The two nearest boundary points Np are included in the respective left and right highlighted images

That is, the CPU 31 determines whether the two nearest boundary points Np, each of which has the same minimum distance relative to the vehicle V, are included in the respective left and right highlighted images in step S340.

Upon determination that the two nearest boundary points Np are included in the respective left and right highlighted images (YES in step S340), the subroutine proceeds to step S350.

In step S350, the CPU 31 selects, from the left and right highlighted images, one of the left and right highlighted images, which is closer to the front passenger seat of the vehicle V than the other is, thus setting the selected one of the left and right highlighted images as the near-field image in step S350. After selection of one of the left and right highlighted images as the near-field image, the CPU 31 terminates the subroutine, and returns to step S200 of the main display routine.

For example, if the vehicle V is a right-hand steering vehicle, the CPU 31 selects, from the left and right highlighted images, the left highlighted image, thus setting the selected left highlighted image as the near-field image in step S350. Otherwise, if the vehicle V is a left-hand steering vehicle, the CPU 31 selects, from the left and right highlighted images, the right highlighted image, thus setting the selected right highlighted image as the near-field image in step S350.

Note that information about whether the vehicle V is a right-hand steering vehicle or a left-hand steering vehicle can be stored in the memory 32 during manufacturing of the vehicle V. This enables the CPU 31 to easily determine whether the vehicle V is a right-hand steering vehicle or a left-hand steering vehicle based on the information stored in the memory 32.

Otherwise, upon determination that the detected at least one nearest boundary point Np is one nearest boundary point Np or that the two nearest boundary points Np are not included in the respective left and right highlighted images (NO in step S340), the subroutine proceeds to step S360.

In step S360, the CPU 31 selects, from the left and right highlighted images, one of the left and right highlighted images, which includes the detected at least one nearest boundary point Np, thus setting the selected one of the left and right highlighted images as the near-field image in step S360. After selection of one of the left and right highlighted images as the near-field image, the CPU 31 terminates the subroutine, and returns to step S200 of the main display routine.

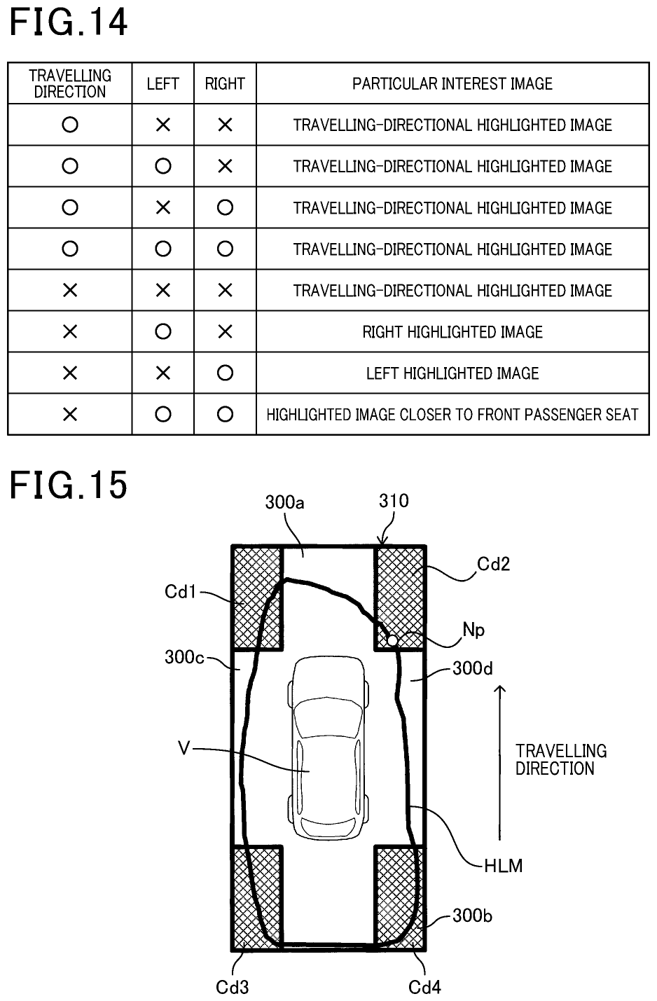

FIG. 14 schematically illustrates, using a table format, an example of the relationship among

(1) The detected at least one nearest boundary point Np

(2) At least one of the travelling-directional highlighted image, the left highlighted image, and the right highlighted image, which includes the at least one nearest boundary point

(3) A particular interest image displayed on the display region 20a of the display 21

In FIG. 14, each of circle symbols represents a highlighted image in which at least one nearest boundary point Np is detected, and each of X symbols represents a highlighted image in which no nearest boundary points Np are detected.

For example, the table illustrated in FIG. 14 is comprised of a header row, and first to eighth rows; each of the first to eighth rows is comprised of first to fourth cells from the left:

The first cell represents whether at least one nearest boundary point Np is detected in the travelling-directional highlighted image

The second cell represents whether at least one nearest boundary point Np is detected in the left highlighted image

The third cell represents whether at least one nearest boundary point Np is detected in the right highlighted image

The fourth cell represents which of the travelling-directional highlighted image, left highlighted image, and right highlighted image is selected as the near-field image

Specifically, the first row of the table illustrated in FIG. 14 shows that

(1) At least one nearest boundary point Np is detected in the travelling-directional highlighted image (see the circle symbol assigned to the first cell)

(2) No nearest boundary points Np are detected in each of the left and right highlighted images (see the X symbols assigned to the respective second and third cells)

(3) The travelling-directional highlighted image is selected as the near-field image, so that a particular interest image based on the selected travelling-directional highlighted image is displayed on the display 21

Similarly, the fourth row of the table illustrated in FIG. 14 shows that

(1) At least one nearest boundary point Np is detected in each of the travelling-directional highlighted image, left highlighted image, and right highlighted image (see the circle symbols assigned to the respective first to third cells)

(2) The travelling-directional highlighted image is selected as the near-field image, so that a particular interest image based on the selected travelling-directional highlighted image is displayed on the display 21

Additionally, the eighth row of the table illustrated in FIG. 14 shows that

(1) No nearest boundary points Np are detected in the travelling-directional highlighted image (see the X symbol assigned to the first cell)

(2) Two nearest boundary points Np are detected in the respective left and right highlighted images (see the X symbols assigned to the respective second and third cells)

(3) One of the left and right highlighted image, which is closer to the passenger seat, is selected as the near-field image, so that a particular interest image based on the selected highlighted image is displayed on the display 21

That is, the CPU 31 is configured to set the travelling-directional highlighted image as the near-filed image if at least one nearest boundary point Np is included in the travelling-directional highlighted image, or no nearest boundary points Np are detected from all the highlighted images.

The CPU 31 is also configured to set one of the left and right highlighted image, which is closer to the passenger seat, as the near-field image if no nearest boundary points Np are detected in the travelling-directional highlighted image, and two nearest boundary points Np are detected in the respective left and right highlighted images.

The CPU 31 is further configured to set a selected one of the left and right highlighted image as the near-field image if no nearest boundary points Np are detected in the travelling-directional highlighted image, and a nearest boundary point Np is detected in the selected one of the left and right highlighted images.

As described in detail above, the ECU 30, which serves as, for example, an image processing apparatus, of the image display system 1 according to the exemplary embodiment is configured to

(1) Generate a surrounding image that shows, for example, one of the front, rear, left, and right view fields with respect to the vehicle V, and a collective birds'-eye image that shows an image of a road surface around the vehicle V viewed from a virtual camera located above the vehicle V

(2) Display, on the display region 20a of the display 21, the surrounding image and the collective birds'-eye image

(3) Visually distinguish, in each of the surrounding image and the collective birds'-eye image, a travelable region that shows a road-surface region that is freely travelable for the vehicle V and a non-travelable region that shows a region, except for the travelable region, that is non-travelable for the vehicle V

This configuration improves the viewability of a boundary between the travelable region and the non-travelable region in each of the surrounding image and the collective birds'-eye image. This therefore enables a driver of the vehicle V to easily recognize the boundary between the travelable region and the non-travelable region in each of the surrounding image and the collective birds'-eye image, thus improving the driving safety of the vehicle V.

The ECU 30 of the exemplary embodiment is configured to highlight at least the boundary between the travelable region and the non-travelable region in each of the surrounding image and the collective birds'-eye image.

This configuration further improves the viewability of a boundary between the travelable region and the non-travelable region in each of the surrounding image and the collective birds'-eye image. This therefore enables a driver of the vehicle V to more easily recognize the boundary between the travelable region and the non-travelable region in each of the surrounding image and the collective birds'-eye image, thus further improving the driving safety of the vehicle V.

The ECU 30 of the exemplary embodiment is configured to

(1) Generate, as the surrounding image, a particular interest image including at least one nearest boundary point Np existing around the vehicle V

(2) Display, on the display region 20a of the display 21, the particular interest image in addition to the collective birds'-eye image that shows the surrounding of the vehicle V

The at least one nearest boundary point Np represents the position of at least one solid object around the vehicle V located at the closest position to the vehicle V.

This enables a driver of the vehicle V to visibly recognize the position of the at least one nearest boundary point Np in the particular interest image, thus still further improving the driving safety of the vehicle V.

FIG. 15 schematically illustrates an example of a collective bird's-eye image 310 comprised of front, rear, left and right bird's-eye view images 300a, 300b, 300c, and 300d, which is generated by the ECU 30. In the collective bird's-eye view image 310, a highlighted line marker HLM is included to highlight the boundary Le including a nearest boundary point Np.

In particular, the front bird's-eye image 300a and the left bird's-eye image 300c partially overlap each other, the overlapped region will be referred to as an overlapped region Cd1. Additionally, the front bird's-eye image 300a and the right bird's-eye image 300d partially overlap each other, the overlapped region will be referred to as an overlapped region Cd2.

Similarly, the rear bird's-eye image 300b and the left bird's-eye image 300c partially overlap each other, the overlapped region will be referred to as an overlapped region Cd3. Additionally, the rear bird's-eye image 300b and the right bird's-eye image 300d partially overlap each other, the overlapped region will be referred to as an overlapped region Cd4.

At that time, even if the nearest boundary point Np is located in the overlapped region Cd2 between the front and right bird's-eye images 300a and 300d, the ECU 30 is capable of selecting a near-field image from the front, rear, left, and right highlighted images in step S190.

Specifically, if the vehicle V is travelling in the front direction while the nearest boundary point Np is located in the overlapped region Cd2 between the front and right bird's-eye images (front and right highlighted images) 300a and 300d, the CPU 31 of the ECU 30 preferentially selects, from the front and right bird's-eye images 300a and 300d, the front bird's-eye image 300a, which shows the travelling directional view, as a near-field image. This results in a particular interest image based on the front bird's-eye view image being displayed on the display region 20a of the display 21 (see the third row of the table illustrated in FIG. 14).

Displaying the particular interest image based on the front bird's-eye view image, which shows the travelling directional view, contributes to preventing the vehicle V from entering the non-travelable region including the nearest boundary point Np.

If no nearest boundary points Np are located in the travelling-directional highlighted image, but two nearest boundary points Np are located in the respective left and right highlighted images, the CPU 31 of the ECU 30 preferentially selects, from the left and right highlighted images, one of the left and right highlighted images, which is closer to the front passenger seat of the vehicle V than the other is as a near-field image. This results in a particular interest image based on one of the left and right highlighted images, which is closer to the front passenger seat, being displayed on the display region 20a of the display 21 (see the eighth row of the table illustrated in FIG. 14).

This enables a driver of the vehicle V to reliably view a region around the passenger seat of the vehicle V, which may be difficult for a driver of the vehicle V to view, making it possible to increase the driving safety level of the vehicle V.

The ECU 30 of the exemplary embodiment is configured to

(1) Set the position of a viewpoint and a viewing direction of the virtual camera Pi in accordance with the positional relationship between a nearest boundary point Np and the position of the vehicle V such that the nearest boundary point Np is included in a viewing region of the virtual camera Pi

(2) Generate a particular interest image based on the position of the viewpoint and the viewing direction of the virtual camera Pi

(3) Display the particular image on the display region 20a of the display 21

This enables the nearest boundary point Np to be clearly captured in the particular image.

The ECU 30 of the exemplary embodiment is configured to perform a known semantic segmentation task of each of the captured images to thereby partition the total region of each of the captured images into plural segments; each pixel of each segment has an individual unique category label. Then, the ECU 30 is configured to identity, based on the partitioned segments, a travelable region and a non-travelable region in each of the captured images.

Let us consider a comparative image processing apparatus that

(1) Detects solid objects located around the vehicle V using a sensor

(2) Performs image processing to thereby identify the location of each detected solid object as a non-travelable region on which the vehicle V cannot travel

The comparative image processing apparatus however cannot display one or more regions in which no solid objects are detected as one or more non-travelable regions even if the vehicle V cannot travel in the one or more regions.

In contrast, the ECU 30 of the exemplary embodiment identities, based on the partitioned segments, a travelable region and a non-travelable region in each of the captured images, making it possible to identify one or more regions in which no solid objects are detected but the vehicle V cannot travel as one or more non-travelable regions.

Partitioning one or more regions in which the vehicle V preferably does not travel, such as frozen road-surface regions, into one or more non-travelable regions enables the one or more regions in which the vehicle V preferably does not travel to be recognized as non-travelable regions.

### MODIFICATIONS

The exemplary embodiment of the present disclosure has been described in detail, but the present disclosure is not limited to the exemplary embodiment, and can be variously modified.

The ECU 30 of the exemplary embodiment determines which class in the previously defined annotation classes each pixel of a captured image belongs to; the annotation classes include the free space region (free space class) Bf, the own vehicle region (own vehicle class) Ba, the ineffective regions (ineffective classes) Bb, and the other region (other class) Bo.

The present disclosure is however not limited to the above four classes as the annotation classes. Specifically, the annotation classes can include target-type classes of respective various types of targets to be detected, and solid-object type classes of respective various types of solid objects. That is, the ECU 30 can be configured to

(1) Determine which class in the target-type classes and the solid-object type classes in the annotation classes each pixel of a captured image belongs to

(2) Identify whether each pixel of the captured image, which belongs to the determined class, is identified as a travelable region or a non-travelable region

The ECU 30 of the exemplary embodiment is configured to obtain plural images captured by the cameras 10, but the present disclosure is not limited to this configuration. Specifically, the ECU 30 can be configured to obtain an image captured by a single camera, i.e. a single imaging device, 10. In this modification, the ECU 30 performs bird's-eye view conversion of a highlighted image based on the captured image to thereby obtain a bird's-eye view image in place of the collective bird's-eye view image 300 in step S160. That is, the ECU 30 of this modification can perform the subsequent operations from the operation in step S160 using the bird's-eye view image in place of the collective bird's-eye view image 300.

The ECU 30 of the exemplary embodiment is configured to start the display routine in response to a driver's touch operation of the visual start switch on the start image displayed on the image display region 21a of the display 21, but the present disclosure is not limited to this configuration.

Specifically, the ECU 30 can be configured to start the display routine in response to when the shift lever is shifted to the reverse range.

The ECU 30 of the exemplary can be configured to superimpose at least one of

(1) A highlighted marker or a highlighted image on the location of the boundary in a particular interest image

(2) A travelable-region highlighted image on a travelable region in the particular interest image

(3) A non-travelable-region highlighted image on a non-travelable region in the particular interest image

This highlights at least one of the boundary between the travelable region and non-travelable region, the travelable region, and the non-travelable region. The ECU 30 of the exemplary can also be configured to superimpose, on the particular interest image, a combination of at least at least two of the highlighted marker, travelable-region highlighted image, and non-travelable-region highlighted image.

The ECU 30 of the exemplary embodiment is configured to

(1) Perform the near-field bird's-eye view conversion of the near-field image, which includes at least one nearest boundary point Np, to thereby convert the near-field image into a near-field bird's-eye view image

(2) Perform the middle-field bird's-eye view conversion of the near-field image, which includes the at least one nearest boundary point Np, to thereby convert the near-field image into a middle-field bird's-eye view image

The present disclosure is however not limited to this configuration.

Specifically, the ECU 30 can be configured to

(1) Perform the near-field bird's-eye view conversion of each highlighted image to thereby convert the near-field image into a near-field bird's-eye view image that shows an image viewed from a virtual camera Pi located around the vehicle V

(2) Perform the middle-field bird's-eye view conversion of each highlighted image to thereby convert the near-field image into a middle-field bird's-eye view image that shows an image viewed from the virtual camera Pi located around the vehicle V

The functions of one element in the above embodiment can be distributed as plural elements, and the functions that plural elements have can be combined into fewer elements. At least part of the structure of the above embodiment can be replaced with a known structure having the same function as the at least part of the structure of the embodiment. A part of the structure of the above embodiment can be eliminated. All aspects included in the technological ideas specified by the language employed by the claims constitute embodiments of the present disclosure.

The present disclosure can be implemented by various embodiments in addition to the image processing apparatus, such as the ECU 30, of the above embodiment; the various embodiments include systems each including the image processing apparatus, programs for serving as a computer as the image processing apparatus, storage media, such as non-transitory storage media, storing the programs, and image processing methods.

While the illustrative embodiment and its modifications of the present disclosure have been described herein, the present disclosure is not limited to the embodiments and their modifications described herein. Specifically, the present disclosure includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An image processing apparatus comprising:
an image obtaining unit configured to obtain an image of a region around a vehicle captured by an imaging device;
a region identifier configured to identify, based on the obtained image, a travelable region and a non-travelable region in the obtained image, the travelable region being a region that is travelable for the vehicle, the non-travelable region being a region except for the travelable region in the obtained image;
a boundary identifier configured to identify, in the obtained image, a boundary between the travelable region and non-travelable region; and
an image display unit configured to display the travelable region and non-travelable region while distinguishing the travelable region and non-travelable region from one another.

2. The image processing apparatus according to claim 1, wherein:
the region identifier includes a partitioning unit configured to perform a semantic segmentation task on the obtained image to thereby:
determine which class in previously defined annotation classes each pixel of the obtained image belongs to, the previously defined annotation classes being associated with a travelling environment around the vehicle; and
assign, to each pixel of the obtained image, the determined class to accordingly partition the obtained image into a plurality of segments,
the region identifier being configured to identify the travelable region and the non-travelable region in the obtained image in accordance with the segments.

3. The image processing apparatus according to claim 1, wherein the image display unit includes:
a highlighting unit configured to highlight, in the obtained image, a location of the boundary identified by the boundary identifier to thereby generate a highlighted image including the highlighted location of the boundary.

4. The image processing apparatus according to claim 3, wherein:
the highlighting unit is configured to highlight at least one of the travelable region and non-travelable region while visibly distinguishing the travelable region and non-travelable region from one another.

5. The image processing apparatus according to claim 4, wherein:
the highlighting unit is configured to cause a display mode of the travelable region to be different from a display mode of the non-travelable region.

6. The image processing apparatus according to claim 3, further comprising:
a bird's-eye view converter configured to perform bird's-eye view conversion of the highlighted image generated by the highlighting unit to thereby obtain a bird's-eye view image, the bird's-eye view image showing an image viewed from a predetermined position above the vehicle,
wherein:
the image display unit is configured to display the bird's-eye view image obtained by the bird's-eye view converter.

7. The image processing apparatus according to claim 1, wherein:
the image display unit includes:
a distance calculating unit configured to calculate, for the obtained image, a minimum distance between each boundary point on the boundary and a predetermined point located at a predetermined position of the vehicle in the obtained image; and
a particular interest image generator configured to:
extract, from the boundary points, at least one boundary point whose minimum distance is the shortest as at least one nearest boundary point; and
perform, based on a positional relationship between the at least one nearest boundary point and the vehicle, bird's-eye view conversion of the obtained image to thereby obtain a particular interest image, the particular interest image showing an image viewed from a predetermined position above the vehicle, and including the nearest boundary point; and
a display unit configured to display the particular interest image generated by the particular interest image generator.

8. The image processing apparatus according to claim 7, further comprising:
an adjusting unit configured to adjust, based on the positional relationship between the at least one nearest boundary point and the vehicle, at least one of the location of a virtual camera and a direction of the optical axis of the virtual camera such that the nearest boundary point is viewable by the virtual camera,
the particular interest image generator being configured to perform the bird's-eye view conversion of the obtained image to thereby obtain the particular interest image viewed from the virtual camera having the adjusted optical axis and located at the adjusted position above the vehicle.

9. The image processing apparatus according to claim 8, wherein:
the adjusting unit is configured to:
determine, based on the positional relationship between the at least one nearest boundary point and the vehicle, whether the at least one nearest boundary point is located within a predetermined first range around the vehicle or a predetermined second range around the vehicle, the first range being closer to the vehicle than the second range is;
adjust the location and optical axis of the virtual camera such that the virtual camera is able to view the first range upon determination that the at least one nearest boundary point is located within the predetermined first range; and
adjust the location and optical axis of the virtual camera such that the virtual camera is able to view the second range upon determination that the at least one nearest boundary point is located within the predetermined second range.

10. The image processing apparatus according to claim 3, wherein:
the image display unit includes:
a distance calculating unit configured to calculate, for the obtained image, a minimum distance between each boundary point on the boundary and a predetermined point located at a predetermined position of the vehicle in the highlighted image; and
a particular interest image generator configured to:
extract, from the boundary points, at least one boundary point whose minimum distance is the shortest as at least one nearest boundary point; and
perform, based on a positional relationship between the at least one nearest boundary point and the vehicle, bird's-eye view conversion of the highlighted image to thereby obtain a particular interest image, the particular interest image showing an image viewed from a predetermined position above the vehicle, and including the nearest boundary point; and
a display unit configured to display the particular interest image generated by the particular interest image generator.

11. The image processing apparatus according to claim 10, further comprising:
an adjusting unit configured to adjust, based on the positional relationship between the at least one nearest boundary point and the vehicle, at least one of the location of a virtual camera and a direction of the optical axis of the virtual camera such that the nearest boundary point is viewable by the virtual camera,
the particular interest image generator being configured to perform the bird's-eye view conversion of the highlighted image to thereby obtain the particular interest image viewed from the virtual camera having the adjusted optical axis and located at the adjusted position above the vehicle.

12. The image processing apparatus according to claim 11, wherein:
the adjusting unit is configured to:
determine, based on the positional relationship between the at least one nearest boundary point and the vehicle, whether the at least one nearest boundary point is located within a predetermined first range around the vehicle or a predetermined second range around the vehicle, the first range being closer to the vehicle than the second range is;
adjust the location and optical axis of the virtual camera such that the virtual camera is able to view the first range upon determination that the at least one nearest boundary point is located within the predetermined first range; and
adjust the location and optical axis of the virtual camera such that the virtual camera is able to view the second range upon determination that the at least one nearest boundary point is located within the predetermined second range.

13. The image processing apparatus according to claim 6, wherein:
the image display unit includes:
a distance calculating unit configured to calculate, for the obtained image, a minimum distance between each boundary point on the boundary and a predetermined point located at a predetermined position of the vehicle in the highlighted image; and
a particular interest image generator configured to:
extract, from the boundary points, at least one boundary point whose minimum distance is the shortest as at least one nearest boundary point; and
perform, based on a positional relationship between the at least one nearest boundary point and the vehicle, bird's-eye view conversion of the highlighted image to thereby obtain a particular interest image, the particular interest image showing an image viewed from a predetermined position above the vehicle, and including the nearest boundary point; and
a display unit configured to display, on a display region of a display, both:
the bird's-eye view image obtained by the bird's-eye view converter; and
the particular interest image generated by the particular interest image generator.

14. A computer-readable storage medium comprising a set of computer program instructions, the instructions causing a computer to carry out:
a first step of obtaining an image of a region around a vehicle captured by an imaging device;
a second step of identifying, based on the obtained image, a travelable region and a non-travelable region in the obtained image, the travelable region being a region in which the vehicle is travelable, the non-travelable region being a region except for the travelable region in the obtained image;
a third step of identifying, in the obtained image, a boundary between the travelable region and non-travelable region; and
a fourth step of displaying, on a display, the travelable region and non-travelable region while distinguishing the travelable region and non-travelable region from one another.
